(19) United States
(12) Patent Application Publication
(10) Pub. No.: US 2013/0176463 A1
(43) Pub. Date: Jul. 11, 2013

(54) Method and Apparatus for Image Scaling in Photography

(71) Applicant: Olli HYVARINEN, Tampere (FI)

(72) Inventor: Olli HYVARINEN, Tampere (FI)

(73) Assignee: Nokia Corporation

(21) Appl. No.: 13/345,891

(22) Filed: Jan. 9, 2012

(51) Int. Cl. H04N 5/262

(52) U.S. Cl. 348/240.99; 348/E05.055

(57) ABSTRACT

Digital camera or device comprising is digital camera unit is controlled in a process having steps of: receiving images from an image sensor of a digital camera unit; and in a first operational state, determining a change in the size of objects in the received images and to responsively causing changing of zooming by the digital camera unit in compensation of the determined change.

### TECHNICAL FIELD

The present application generally relates to image scaling in photography.

### BACKGROUND

The ability to take good photographs is one of the skills that come naturally from talented photographers or most people learn with practice. Various aids have been provided for helping the photographer, such as a grid view on the viewfinder to help in designing layout of the photo. For avoiding motion blur caused by handshake, optical and digital image stabilization techniques have been designed and numerous other helpful technologies have been designed since the camera was first invented. Automatic control of shutter, exposure time, white balance and focusing each greatly ease the life of the photographer. However, it remains a fact that a human brain forms an image of the surroundings as seen by the eyes at different times and from all different directions to which a person has looked. It is impossible to match that perception with a camera and therefore the photographer ultimately has to make essential decisions about framing her images. With regard to the framing, there are at least three different factors to account for. First, the photographer has to decide exactly from where the image is taken. Second, she has to aim the camera to a direction of her choice (horizontally, vertically and choose desired rotation (e.g. landscape, portrait or some oblique angle). Third, the photographer may be able to adjust focal length by choice of objective (if replaceable) or by use of a zoom, if the camera has a zoom function.

### SUMMARY

Various aspects of examples of the invention are set out in the claims.

According to a first example aspect of the present invention, there is provided an apparatus, comprising:

an input configured to receive images from an image sensor of a digital camera unit;

the apparatus having a first operational state; and;

a processor configured, when the apparatus is in a first operational state, to determine a change in the size of objects in the received images and to responsively cause changing of zooming by the digital camera unit in compensation of the determined change.

The processor may be further configured, when the apparatus is in a second operational state, to abstain from at least one of the determining of the change in the size of objects in the received images and the causing of the changing of zooming by the digital camera unit in compensation of the determined change.

The determination of the change in the size of objects in the received images may be performed for more than one successive images based on a constant reference image produced from earlier received images.

The reference image may be the first received image after the apparatus has entered the first operational state. Alternatively, the reference image may be first such received image after the apparatus has entered the first operational state that meets one or more predetermined quality requirements. The quality requirements may comprise a measure of focusing, brightness of the image and a measure of sharpness of the image.

The reference image may be produced from two or more of the received images. One or more of the received images may be selected using the quality requirements as a condition for accepting a received image for use in the producing of the reference image.

The digital camera unit may comprise an optical zoom and an actuator controllable by the processor. Alternatively, the digital camera may lack an optical zoom and/or an actuator for an optical zoom controllable by the processor, in which case, the processor may be configured to perform the causing of the changing of zooming by causing changing of digital zooming. The processor itself may perform the digital zooming. Alternatively, the processor may cause another element to perform the digital zooming.

The camera unit may comprise an autofocus unit configured to maintain an image object in focus. The autofocus unit may automatically correct changes in focusing of the image object. The processor may be configured to cause informing the autofocus unit of the direction of change in which the focus should be corrected, based on the change in the size of the image object in the received images.

The apparatus may further comprise an image stabilization circuitry comprising a detector configured to detect changes in the field of images and a compensating circuitry configured to cause the camera unit to compensate for the detected changes in the field of the images.

The detector may comprise a gyroscope, acceleration sensor or a mechanical element configured to detect changes in the orientation of the digital camera unit. Alternatively or additionally, the detector may comprise a signal processing element configured to detect changes in the images produced by the image sensor. The signal processing element may comprise or be comprised by the processor.

The compensating circuitry may be configured to cause digital image stabilization. The image stabilization circuitry may be configured to cause the camera unit to form images of multiple frames. The exposure time of the frames may be the minimum enabled by the image sensor or the image sensor and downstream components (such as data buses and processing circuitries). The compensating circuitry may be configured to align pixels of subsequent ones of the multiple frames so that motion caused changes from one frame to another are reduced. The compensating circuitry may comprise or be comprised by the processor.

The compensating circuitry may be configured to perform image stabilization such that the subsequent ones of the multiple frames are normalized in scale before the aligning of the pixels so as to compensate blur caused by motion of the camera unit closer and farther away from the image object while an image is being exposed.

The apparatus may further comprise a memory configured to store the received images.

The apparatus may be configured to enter into the first operational state in response to receiving a first user command.

The processor may be configured to detect when first criteria are met and responsively cause the apparatus to enter into the first operational state. The first criteria may comprise detecting that the camera unit is performing macro imaging or that the distance from the camera unit to an imaging target is smaller than a lower limit. The first criteria may further comprise detecting that changes in the received images or in an image object in the received images have remained below a given change threshold.

The apparatus may be further configured to enter into the second operational state in response to receiving a first user command.

The processor may be configured to detect when a second criterion is met and responsively cause the apparatus to enter into the second operational state. The second criterion be selected from a group consisting of: detecting that the camera unit is not performing macro imaging; detecting that the distance from the camera unit to an imaging target is not smaller than a lower limit; detecting that changes in the received images have remained below a given change threshold; and detecting that changes in an image object in the received images have remained below a given change threshold.

According to a second example aspect of the present invention, there is provided a method comprising:
receiving images from an image sensor of a digital camera unit; and
in a first operational state, determining a change in the size of objects in the received images and to responsively causing changing of zooming by the digital camera unit in compensation of the determined change.

The method may further comprise, in a second operational state, abstaining from at least one of the determining of the change in the size of objects in the received images and the causing of the changing of zooming by the digital camera unit in compensation of the determined change.

The method may further comprise determining whether the first operational state is in use or a second operational state is in use.

According to a third example aspect of the present invention, there is provided a computer program comprising computer executable program code, configured to cause an apparatus, when executing the program code, to perform the method of the second aspect.

According to a fourth example aspect of the present invention, there is provided a computer readable memory medium storing the computer program of the third example aspect.

According to a fifth example aspect of the present invention, there is provided an apparatus comprising a processor configured to:
receiving images from an image sensor of a digital camera unit; and
in a first operational state, determining a change in the size of objects in the received images and to responsively causing changing of zooming by the digital camera unit in compensation of the determined change.

According to a sixth example aspect of the present invention, there is provided an apparatus comprising:
at least one processor; and
at least one memory including computer program code
the at least one memory and the computer program code configured to, with the at least one processor, cause the apparatus to perform at least the following:
receiving images from an image sensor of a digital camera unit; and
in a first operational state, determining a change in the size of objects in the received images and to responsively causing changing of zooming by the digital camera unit in compensation of the determined change.

According to a seventh example aspect of the present invention, there is provided a computer program product comprising a computer-readable medium bearing computer program code embodied therein for use with a computer, the computer program code comprising:
code for receiving images from an image sensor of a digital camera unit; and
code for, in a first operational state, determining a change in the size of objects in the received images and responsively causing changing of zooming by the digital camera unit in compensation of the determined change.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a schematic system 100 for use as a reference with which some example embodiments of the invention can be explained;

FIG. 2 illustrates an exaggerated hand shake situation;

FIGS. 3a and 3b show two images taken by the camera unit respecting the impact of movement of a device from a first spatial state to a second spatial state;

FIG. 4 shows a block diagram of an apparatus of an example embodiment of the invention;

FIG. 5 shows a block diagram of a camera unit of an example embodiment of the invention; and

FIG. 6 shows a flow chart of a process according to an example embodiment of the invention.

### DETAILED DESCRIPTION OF THE DRAWINGS

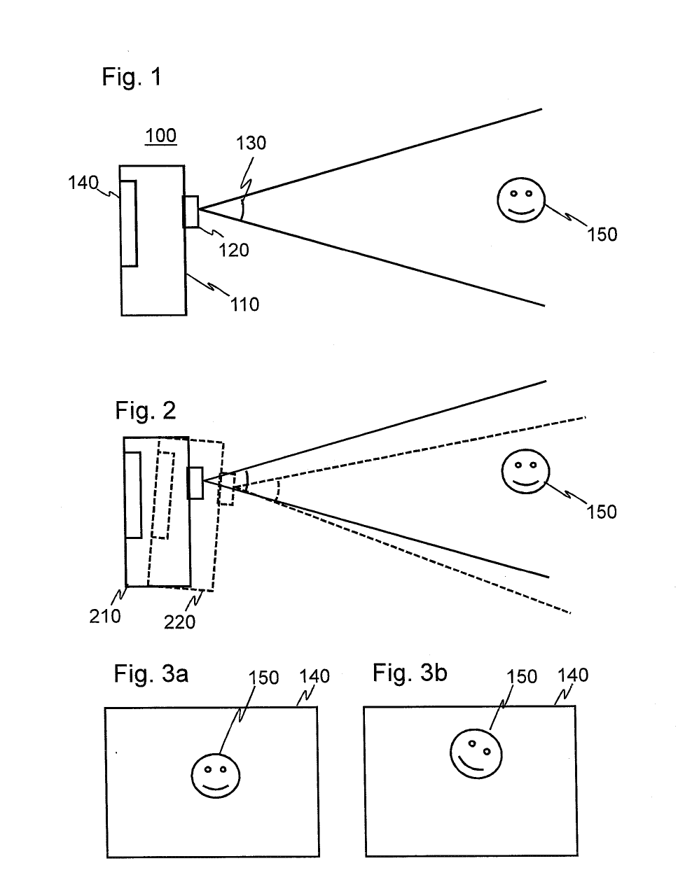

An example embodiment of the present invention and its potential advantages are understood by referring to FIGS. 1 through 6 of the drawings.

Various examples will next be described to illustrate different example embodiments of the invention. The structures of these embodiments may be varied in many ways and it makes the description simpler and clearer to first present a basic system in which the embodiments are described, then discuss various operations according to different example embodiments and finally explain various structures with which these operations can be implemented.

FIG. 1 shows a schematic system 100 for use as a reference with which some example embodiments of the invention can be explained. The system 100 comprises a device 110 such as a camera phone or a digital camera having a camera unit 120 with a field of view 130. The system 100 further comprises a display 140. FIG. 1 also shows an image object 150 that is being imaged by the camera unit 120.

FIG. 2 illustrates an exaggerated hand shake situation, without compensating operations, where the device 110 moves from a first spatial state 210 and to a second spatial state 220. It is assumed that the hand shake causes motion towards the image object and the device 110 is also tilted down and slightly offset downwards from its first spatial state 210. Moreover, the device 110 is also slightly rotated counter-clockwise. The impact of the movement of the device 110 from the first spatial state 210 to a second spatial state 220 is illustrated by FIGS. 3a and 3b that represent two images taken by the camera unit 120, respectively. If FIG. 3b, the image object appears larger and higher on the display 140 when used as a viewfinder during photographing with the device 110.

In FIGS. 3a and 3b, the image object 150 occupies a greater proportion of the display 140 than of the field of view 130 in FIG. 1. This is because a portion of the camera unit's 120 image sensor is used for digital image stabilization. In effect, in the example embodiment illustrated by FIGS. 3a and 3b, the image sensor has fair margins of pixels that do not normally appear in the images the image sensor provides to the viewfinder or applications using the camera sensor.

The changes in the image object's 150 size are larger when the camera unit 120 is near the image object 150 i.e. while the camera unit 120 operates in macro mode. In this context, the macro mode need not refer to drawing an image of the object in scale 1:1 or as magnified, but rather to taking photographs such that even a relatively small object such as a butterfly becomes well imaged. Typically, the camera unit 120 may operate within a distance up to half a meter or one meter in the macro imaging.

Now, according to an example embodiment of the invention, the device 110 has image stabilization that compensates small changes in the angle of the camera unit 120 caused by handshake of a user who holds the device 110. Of course, the same mechanism works whether the shake is actually resulting from shake of a hand or if the device 110 is e.g. fixed to a car or other shaky support, so let us understand handshake broader to cover also other similar shaking of limited magnitude and fair speed. Image stabilization should not prevent intended change of the field of the view. The image stabilization thus compensates for the vertical change with respect to the image sensor that is caused by tilting and offsetting the camera unit.

In addition to the optical image stabilization, the image scaling is also normalized in an example embodiment. In other words, when the camera unit 120 approaches the image object 150, the image object 150 as seen by the camera unit 120 would normally appear larger (or smaller, when the camera unit 120 moves away from the image object 150). This size increase is compensated by correspondingly zooming out the image.

In one example embodiment, the normalizing of the image scaling is based on two steps. First, the device 110 determines the change in the size of objects in images produced by the camera unit 120, such as the image object 150. Then, the image scaling is adapted either by optical zooming or by digital zooming. In the determining of the change in the size of the objects in the images, a reference image is used that is representative of the scene seen by the camera unit 120. The reference image is, for instance, the first image of the scene with sufficient quality. While blur in the image does not matter when the reference image is only internally used by the device 110, a blurred image may make it difficult to determine the changes in the sizes of objects in the image. Therefore, the reference frame may be the first image that is crisp enough. For instance, the reference frame may be the first image that meets given one or more quality requirements such as: a measure of focusing, brightness of the image and/or a measure of sharpness of the image.

When the normalizing of the image scaling is switched off, the determining of the change in the size of objects in the images and/or the changing of the zooming for normalizing the image scaling can be stopped i.e. the device 110 can abstain from at least one of these operations.

For normalizing the image scaling, optical or electric zooming can be employed. Typically, compact digital cameras have electrically controlled zooming that is readily usable for the normalizing of the image scaling. Some digital cameras are yet equipped solely with manually adjustable optical zooming or have no optical zoom at all. In such a case, the zooming can be performed digitally. Digital zooming can also be used with a digital camera that has also optical zooming, e.g. if it is desired to avoid noise caused by digital zooming and/or to save power.

When the distance between the camera unit 120 and the image object 150 changes, the camera unit 120 may need correction of focusing. Such changes will normally be automatically corrected by autofocus of the camera unit 120. It is also possible to accelerate the autofocus by informing the autofocus of the direction in which the focus should be changed. If optical zooming is employed to normalize of the image scaling, the focusing may change in two ways, affecting in either same or different directions: first, the range has changed and second, the lens system has been rearranged for zooming. If one of these changes is prevalent over the other or if both of these changes affect the zooming in common direction, the autofocus can be simply informed of the direction in which the focusing should be changed. In response, the autofocus of the camera unit 120 starts to seek for better focusing by driving the focusing in the direction informed. Otherwise, the combined effect of the range change and optical zooming can be estimated based on known properties of the camera unit and if the direction in which the focusing should be changed is clear, the autofocus can be informed accordingly.

In case of digital image stabilizing, each of the images produced by the camera unit 120 can be made from multiple frames or by using a multi-frame technique. In the multi-frame technique, each frame is exposed for a short period (e.g. as short a period as possible). The short exposure time typically avoids motion blur but also insufficient exposure. By combining a number of such frames, images of sufficient exposure can be produced. Each frame is aligned with each other so that the pixels representing a given fraction of the image object 150 have matching alignment. Thus, motion of the camera unit 120 is compensated and the image object 150 becomes drawn more crisply that without the electronic image stabilization. As explained in the foregoing, changes in the range between the camera unit 120 and the image object 150 change the size of the image object 150. Such changes in the size of the image object 150 during the exposure period can cause soft edges in images produced by the camera unit 120. If the multi-frame technique is used in conjunction with the normalizing of the image scaling, the frames are normalized in image scaling before combining into an image so that range changes effect is also reduced. In other words, digital range change image stabilization is also provided.

The normalizing of the image scaling is a feature that can be switched on and off according to one example embodiment. The device 110 can have two different operational states, i.e. a first operational state in which the normalizing of the image scaling is in use and a second operational state in which the normalizing of the image scaling is not in use. To this end, a command can be received from a user. As one user-intuitive form, the device 110 can have a three-state selection instead of a normal two-state image stabilization selection: Off, On and Enhanced (with image scaling stabilization).

Alternatively, or in addition to user control, the device 110 can be provided with automatic enabling and/or disabling of the image scaling.

In one example embodiment, the normalizing of the image scaling is switched on on meeting first criteria such as: detecting that the camera unit is performing macro imaging or that the distance from the camera unit to an imaging target is smaller than a lower limit, and detecting that changes in the received images or in an image object in the received images have remained below a given change threshold. The first criteria also comprises, in one example embodiment, detecting that the changes are rapid enough i.e. the rate of changes in the images or in the image object in the received images exceeds a rate threshold.

In one example embodiment, the normalizing of the image scaling is switched off on meeting a second criterion such as: detecting that the camera unit is not performing macro imaging; detecting that the distance from the camera unit to an imaging target is not smaller than a lower limit; detecting that changes in the received images have remained below a given change threshold; and detecting that changes in an image object in the received images have remained below a given change threshold.

In one example embodiment, minor rotation of the images caused by the handshake is also compensated. In one example embodiment, the rotational changes are detected and their nature is evaluated. If the rotational changes are likely unintentional such as of oscillating nature with an amplitude and frequency that corresponds to typical handshake incurred rotational changes in images, the images are straightened. The straightening can be made by rotating the image sensor. Alternatively, the straightening is made digitally making use of the margins of the image sensor of the camera unit 120.

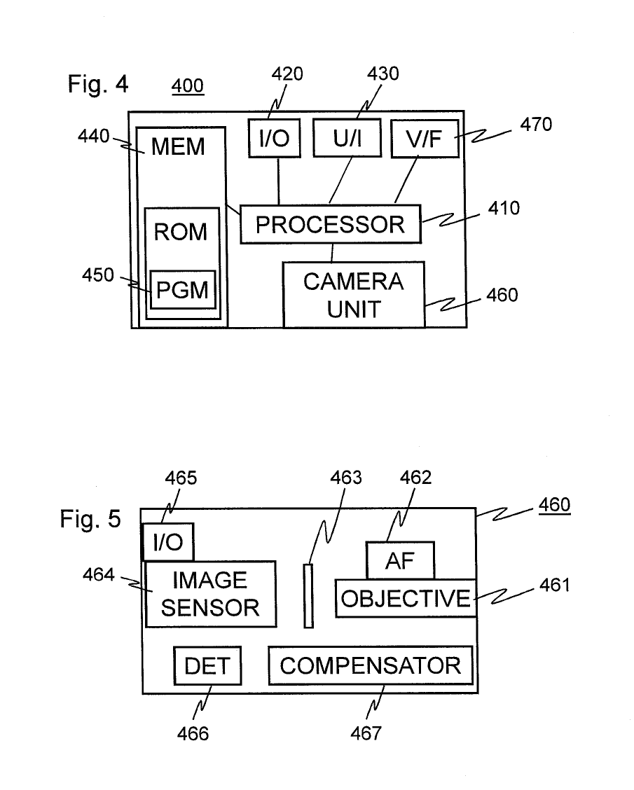

FIG. 4 shows a block diagram of an apparatus 400 of an example embodiment of the invention. The apparatus 400 is suited for operating as the device 110. The apparatus 400 comprises a communication interface 420, a processor 410 coupled to the communication interface module 420, and a memory 440 coupled to the processor 410. The memory 440 comprises a work memory and a non-volatile memory such as a read-only memory, flash memory, optical or magnetic memory. In the memory 440, typically at least initially in the non-volatile memory, there is stored software 450 operable to be loaded into and executed by the processor 410. The software 450 may comprise one or more software modules and can be in the form of a computer program product that is software stored in a memory medium. The apparatus 400 further comprises a camera unit 460 and a viewfinder 470 each coupled to the processor.

It shall be understood that any coupling in this document refers to functional or operational coupling; there may be intervening components or circuitries in between coupled elements.

The communication interface module 420 is configured to provide local communications over one or more local links. The links may be wired and/or wireless links. The communication interface 420 may further or alternatively implement telecommunication links suited for establishing links with other users or for data transfer (e.g. using the Internet). Such telecommunication links may be links using any of: wireless local area network links, Bluetooth, ultra-wideband, cellular or satellite communication links. The communication interface 420 may be integrated into the apparatus 400 or into an adapter, card or the like that may be inserted into a suitable slot or port of the apparatus 400. While FIG. 4 shows one communication interface 420, the apparatus may comprise a plurality of communication interfaces 420.

The processor 410 is, for instance, a central processing unit (CPU), a microprocessor, a digital signal processor (DSP), a graphics processing unit, an application specific integrated circuit (ASIC), a field programmable gate array, a microcontroller or a combination of such elements. FIG. 4 shows one processor 410, but the apparatus 400 may comprise a plurality of processors.

As mentioned in the foregoing, the memory 440 may comprise volatile and a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. In some example embodiments, only volatile or non-volatile memory is present in the apparatus 400. Moreover, in some example embodiments, the apparatus comprises a plurality of memories. In some example embodiments, various elements are integrated. For instance, the memory 440 can be constructed as a part of the apparatus 400 or inserted into a slot, port, or the like. Further still, the memory 440 may serve the sole purpose of storing data, or it may be constructed as a part of an apparatus serving other purposes, such as processing data. Similar options are thinkable also for various other elements.

A skilled person appreciates that in addition to the elements shown in FIG. 4, the apparatus 400 may comprise other elements, such as microphones, displays, as well as additional circuitry such as further input/output (I/O) circuitries, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 400 may comprise a disposable or rechargeable battery (not shown) for powering the apparatus when external power if external power supply is not available.

It is also useful to realise that the term apparatus is used in this document with varying scope. In some of the broader claims and examples, the apparatus may refer to only a subset of the features presented in FIG. 4 or even be implemented without any one of the features of FIG. 4. In one example embodiment term apparatus refers to the processor 410, an input line of the processor 410 configured to receive information from the camera unit and an output line of the processor 410 configured to provide information to the viewfinder.

FIG. 5 shows a block diagram of a camera unit 460 of an example embodiment of the invention. The camera unit 460 comprises an objective 461, an autofocus unit 462 configured to adjust focusing of the objective 461, an optional mechanical shutter 463, an image sensor 464 and an input and/or output 465. The camera unit 460 is configured in one example embodiment to output autofocus information from the autofocus unit 462. In one example embodiment, the camera unit is also configured to receive through the I/O 465 instructions for the autofocus unit 462.

The camera unit 460 further comprises, in one example embodiment, a detector 466 configured detect changes in the field of images and a compensating circuitry 467 configured to cause the camera unit 460 to compensate for the detected changes in the field of the images. The detector 466 comprises, for instance, a gyroscope, acceleration sensor or a mechanical element configured to detect changes in the orientation of the digital camera unit. Alternatively or additionally, in an example embodiment, the detector 466 comprises a signal processing element configured to detect changes in the images produced by the image sensor 464. The signal processing element may comprise or be comprised by the processor 410.

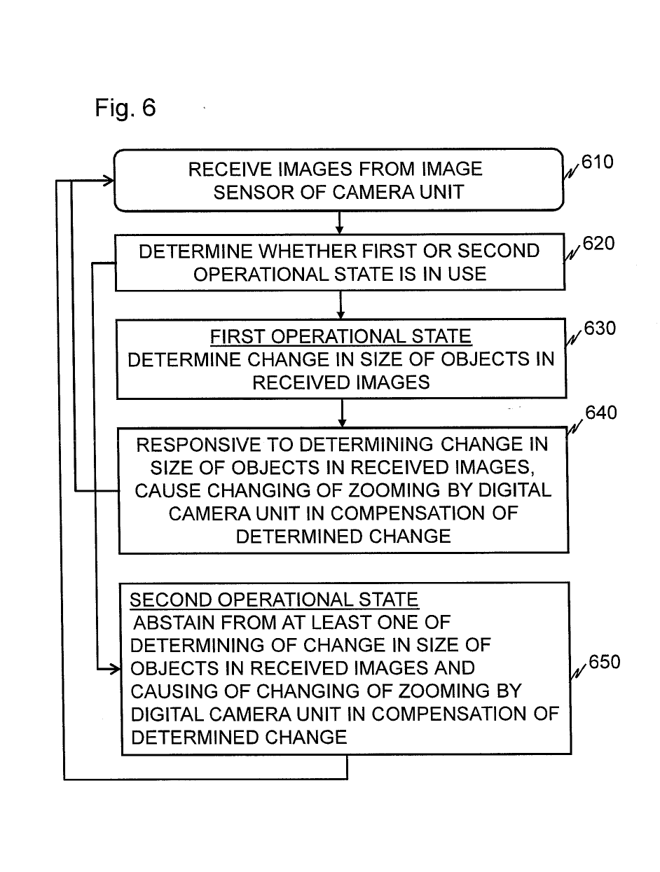

FIG. 6 shows a flow chart of a process according to an example embodiment of the invention. In step 610, images are received from an image sensor of a digital camera unit. There is then determining 620 whether a first operational state is in use or a second operational state is in use and accordingly:
in the first operational state, determining 630 a change in the size of objects in the received images and to responsively causing changing of zooming 640 by the digital camera unit in compensation of the determined change; and
in the second operational state, abstaining 650 from at least one of the determining of the change in the size of objects in the received images and the causing of the changing of zooming by the digital camera unit in compensation of the determined change.

Without in any way limiting the scope, interpretation, or application of the claims appearing below, a technical effect of one or more of the example embodiments disclosed herein is that handshake caused fluctuation of image objects' size on a viewfinder can be eliminated or mitigated. Another technical effect of one or more of the example embodiments disclosed herein is that focus correction can be performed with faster and with less searching when information regarding changes in image size is supplied to an autofocus unit of a digital camera.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined. For instance, showing images on a display functioning as a viewfinder is merely exemplifying one example embodiment.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
an input configured to receive images from an image sensor of a digital camera unit;
the apparatus having a first operational state; and
a processor configured, when the apparatus is in the first operational state, to determine a change in the size of objects in the received images and to responsively cause changing of zooming by the digital camera unit in compensation of the determined change.

2. The apparatus of claim 1, wherein the determination of the change in the size of objects in the received images is performed for more than one successive image based on a constant reference image produced from earlier received images.

3. The apparatus of claim 2, wherein the reference image is the first received image after the apparatus has entered the first operational state.

4. The apparatus of claim 2, wherein the reference image is first such received image after the apparatus has entered the first operational state that meets one or more predetermined quality requirements.

5. The apparatus of claim 4, wherein the quality requirements comprise a measure of focusing, brightness of the image and a measure of sharpness of the image.

6. The apparatus of claim 2, wherein the reference image is produced from two or more of the received images.

7. The apparatus of claim 1, wherein the digital camera unit comprises an optical zoom and an actuator controllable by the processor to perform the changing of the zooming.

8. The apparatus of claim 1, wherein the processor is configured to perform the causing of the changing of zooming by causing changing of digital zooming.

9. The apparatus of claim 1, wherein the camera unit comprises an autofocus unit configured to maintain an image object in focus.

10. The apparatus of claim 9, wherein the processor is configured to cause informing the autofocus unit of the direction of change in which the focus should be corrected, based on the change in the size of the image object in the received images.

11. The apparatus of claim 1, further comprising an image stabilization circuitry comprising a detector configured to detect changes in the field of images and a compensating circuitry configured to cause the camera unit to compensate for the detected changes in the field of the images.

12. The apparatus of claim 11, wherein the compensating circuitry is configured to cause digital image stabilization.

13. The apparatus of claim 12, wherein the compensating circuitry is configured to perform image stabilization such that the subsequent ones of the multiple frames are normalized in scale before the aligning of the pixels so as to compensate blur caused by motion of the camera unit closer and farther away from the image object while an image is being exposed.

14. The apparatus of claim 11, wherein the image stabilization circuitry is configured to cause the camera unit to form images of multiple frames.

15. The apparatus of claim 1, wherein the processor is configured to detect when first criteria are met and responsively cause the apparatus to enter into the first operational state.

16. The apparatus of claim 15, wherein the first criteria comprises detecting that the camera unit is performing macro imaging or that the distance from the camera unit to an imaging target is smaller than a lower limit.

17. The apparatus of claim 16, wherein the first criteria further comprise detecting that changes in the received images or in an image object in the received images have remained below a given change threshold.

18. The apparatus of claim 1, wherein the processor is configured to detect when a second criterion is met and responsively cause the apparatus to enter into the second operational state; wherein the processor is further configured, when the apparatus is in the second operational state, to abstain from at least one of the determining of the change in the size of objects in the received images and the causing of the changing of zooming by the digital camera unit in compensation of the determined change.

19. The apparatus of claim 18, wherein the second criterion is selected from a group consisting of: detecting that the camera unit is not performing macro imaging; detecting that the distance from the camera unit to an imaging target is not smaller than a lower limit; detecting that changes in the received images have remained below a given change threshold; and detecting that changes in an image object in the received images have remained below a given change threshold.

20. A method, comprising:
receiving images from an image sensor of a digital camera unit;
in a first operational state, determining a change in the size of objects in the received images and responsively causing changing of zooming by the digital camera unit in compensation of the determined change.
